(19) United States
(12) Patent Application Publication
(10) Pub. No.: US 2001/0017448 A1
(43) Pub. Date: Aug. 30, 2001

(54) Cutting tool attaching and detaching apparatus of ultrasonic vibration machining device

(76) Inventors: Hideyuki Suzuki, Shizuoka (JP); Hiroshi Watanabe, Shizuoka (JP); Jun Watabe, Shizuoka (JP)

Correspondence Address: ORUM & ROTH, 53 West Jackson Boulevard, Chicago, IL, 60604-3606, US

(21) Appl. No.: 09/792,859

(22) Filed: Feb. 22, 2001

(30) Foreign Application Priority Data
Feb. 24, 2000 (JP) 2000-048134

(51) Int. Cl. B23B 31/20

(52) U.S. Cl. 279/52; 279/59

(57) ABSTRACT

In a cutting tool attaching and detaching apparatus of an ultrasonic vibration machining device, there are provided a collet attaching device and a collet removing device which can be separated from a shank and a collet.

### BACKGROUND OF THE INVENTION

1. Field of the Invention

The present invention relates to a cutting tool attaching and detaching apparatus of an ultrasonic vibration machining device.

2. Description of the Related Art

In the ultrasonic vibration machining device, there is a structure shown in FIG. 12 of a cutting tool attaching and detaching apparatus used to attach and detach a cutting tool of a drill, an end mill cutter or the like to and from a shank (a main shaft), constituting an ultrasonic vibrating body of the machining device. The cutting tool attaching and detaching apparatus in FIG. 12 is structured such that a collet 2 (in which some grooves of slits 2A are alternately provided from an upper end side and a lower end side of a conical pipe) can be taken into a taper hole in a shank 3 so as to be mounted thereto or removed therefrom by attaching a base end of the cutting tool 1 to the collet 2, engaging a projection 5A of an attaching and detaching nut 4 attached to the shank 3 with a ring groove 5B of the collet 2 at a time of connecting a taper surface of the collet 2 to the taper hole of the shank 3 and screwing the attaching and detaching nut 4 with the shank 3.

In accordance with the cutting tool attaching and detaching apparatus shown in FIG. 12, it is possible to rapidly and securely replace the cutting tool without requiring any skill.

However, in the prior art, the attaching and detaching nut 4 having a large outer diameter is always attached to the shank 3 constituting the ultrasonic vibrating body and the attaching and detaching nut 4 causes a mass addition giving a bad influence to the vibration of the ultrasonic vibrating body, as a result, this generates an increase of an oscillating energy of an ultrasonic vibration source and a deterioration of a vibration efficiency and then causes a fatal defect in the ultrasonic vibration machining device.

### SUMMARY OF THE INVENTION

An object of the present invention is to provide an ultrasonic vibration machining device in which it is possible to easily, rapidly and securely replace a cutting tool without adding to a shank constituting an ultrasonic vibrating body.

In accordance with the present invention, there is a cutting tool attaching and detaching apparatus of an ultrasonic vibration machining device in which a base end of a cutting tool is attached to a collet and a taper surface of the collet is connected to a taper hole provided in a shank of the ultrasonic vibration machining device in a taper manner, comprising:

a collet attaching device which is meshed with one of the shank and the collet, is engaged with another thereof in an axial direction, can take and attach the collet into the taper hole of the shank in accordance with a screwing operation between the shank and the collet and can be separated from the shank and the collet; and

a collet removing device which is meshed with one of the shank and the collet, engaged with another thereof in an axial direction, can take and remove the collet from the taper hole of the shank in accordance with a screwing operation between the shank and the collet and can be separated from the shank and the collet.

### BRIEF DESCRIPTION OF THE DRAWINGS

The present invention will be more fully understood from the detailed description given below and from the accompanying drawings which should not be taken to be a limitation on the invention, but are for explanation and understanding only.

The drawings

FIG. 1 is a partly broken front elevational view showing an ultrasonic vibration machining device;

FIG. 2 is a cross sectional view showing a state in which a collet is attached to a shank;

FIG. 3 is a cross sectional view showing a state in which a collet attaching device is used;

FIG. 4 is a cross sectional view showing a state in which a collet removing device is used;

FIGS. 5A and 5b are schematic views showing the collet;

FIG. 6 is a schematic view showing the collet attaching device;

FIG. 7 is a schematic view showing the collet removing device;

FIG. 8 is a schematic view showing a collet attaching and removing device;

FIG. 9 is a cross sectional view showing a state in which the collet removing device and a collet removing piece are used;

FIG. 10 is a bottom elevational view of FIG. 9;

FIG. 11 is a schematic view showing the collet; and

FIG. 12 is a schematic view showing a prior art.

### DESCRIPTION OF THE PREFERRED EMBODIMENTS

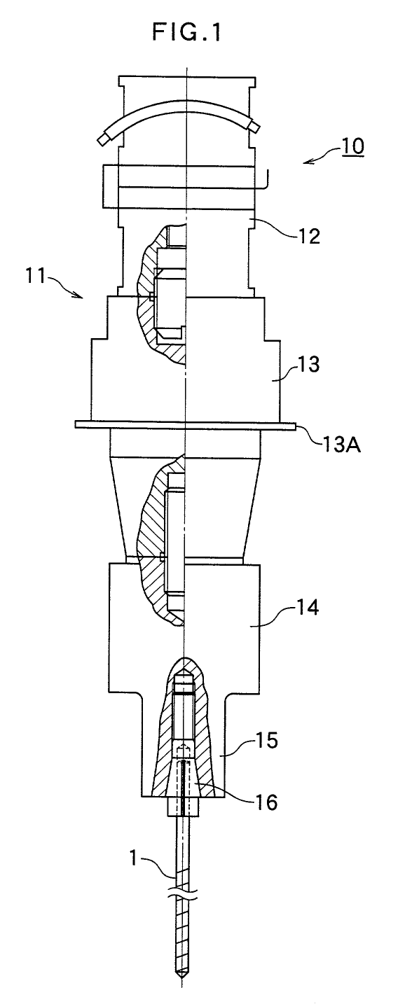

(First Embodiment) (FIGS. 1 to 8)

An ultrasonic vibration machining device 10 shown in FIG. 1 is structured such that an ultrasonic vibrating body 11 is constituted by a bolted body combined with a torsional vibrating element 12, a corn 13 (an amplifying transmitting body of expansion and compression of ultrasonic vibration) and a horn 14. A flange-like mounting portion 13A of the corn 13 can be mounted to a cutting tool table (not shown), and the horn 14 is formed as a shank 15 (a main shaft).

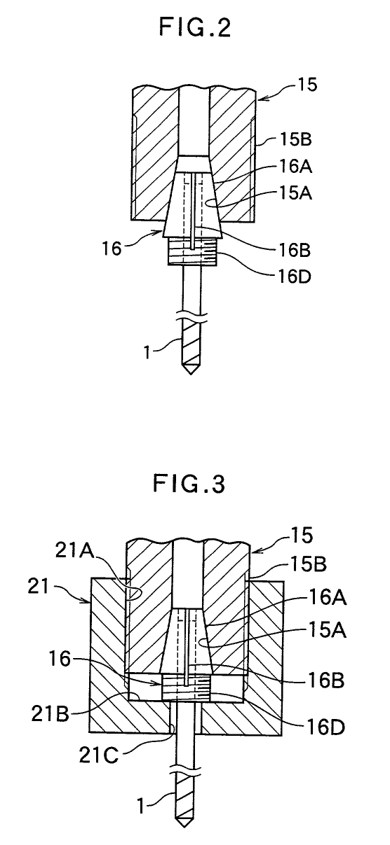

The ultrasonic vibration machining device 10, as shown in FIGS. 1 and 2, is such that a base end of a cutting tool 1 such as a drill, an end mill cutter, a tap, a honing bar or the like is inserted and attached to a collet 16, and a taper surface 16A of the collet 16 can be connected to a taper hole 15A of the shank 15. The collet 16 is structured such that grooves of slits 16B and 16C are alternately applied thereto from an upper end side and a lower end side of a conical pipe as shown in FIGS. 5A and 5B, and the collet 16 is elastically compressed under a state of being inserted and attached to the taper hole 15A of the shank 15 so as to fix the base end of the cutting tool 1. The collet 16 is provided with a screw portion 16D in a large-diameter portion connected to the taper surface 16A.

At this time, in the ultrasonic vibration machining device 10, a collet attaching device 21 and a collet removing device 22 are employed for attaching and detaching the collet 16 to which the base end of the cutting tool 1 is inserted and attached, to the taper hole 15A of the shank 15.

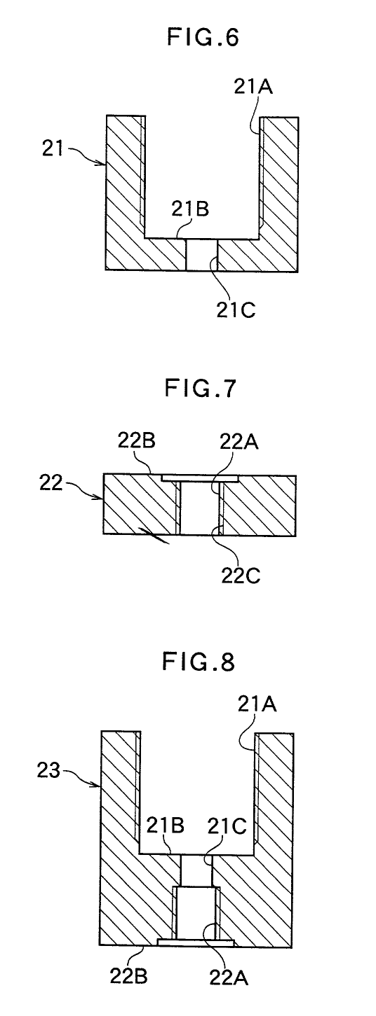

The collet attaching device 21 is provided with a screw portion 21A meshed with an outer peripheral screw portion 15B of the shank 15, an abutting surface 21B engaging with an end surface of the collet 16 in an axial direction, and an insertion hole 21C for the cutting tool 1, as shown in FIG. 3. Accordingly, the collet attaching device 21 can pressure insert the collet 16 into the taper hole 15A of the shank 15 due to a propelling force of the screw generated in accordance with a screwing operation against the shank 15 so as to attach (fix) the collet 16 to the taper hole 15A. The collet 16 and the taper hole 15A of the shank 15 fix the cutting tool 1 to the shank 15 due to a frictional force generated by a taper connection therebetween, and can make the cutting tool 1 be used for an ultrasonic vibration machining. Further, the collet attaching device 21 can be immediately separated by inversely rotating with respect to the screw portion 15B of the shank 15, after attaching the collet 16 to the taper hole 15A of the shank 15. FIG. 6 shows the collet attaching device 21.

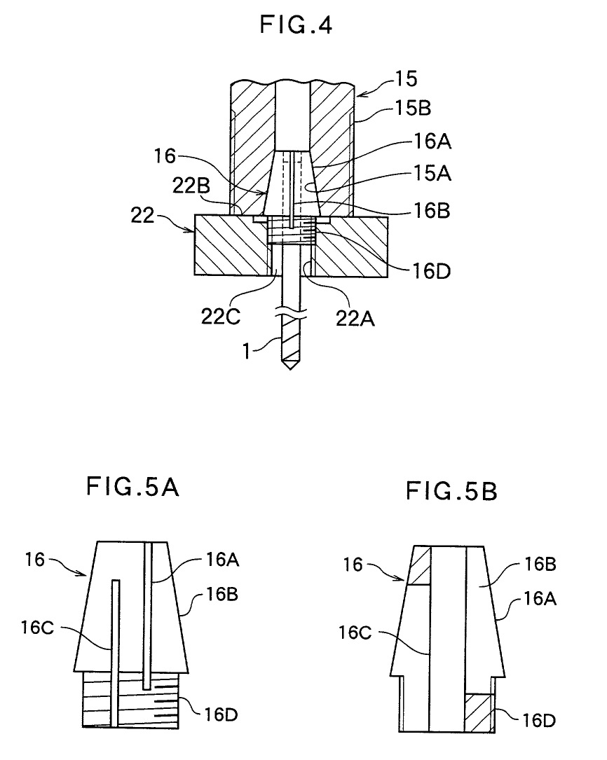

A collet removing device 22 is provided with a screw portion 22A meshed with a screw portion 16D of the collet 16, an abutting surface 22B engaging with an end surface of the shank 15 in an axial direction, and an insertion hole 22C for the cutting tool 1, as shown in FIG. 4. Accordingly, the collet removing device 22 can take out the collet 16 from the taper hole 15A of the shank 15 due to a propelling force of the screw generated in accordance with a screwing operation against the collet 16. Further, the collet removing device 22 can be immediately separated from the shank 15 and the collet 16, after removing the collet 16 from the taper hole 15A of the shank 15. FIG. 7 shows the collet removing device 22.

In this case, the collet attaching device 21 and the collet removing device 22 may be integrally formed so as to be used in a shape of a collet attaching and removing device 23 shown in FIG. 8.

Therefore, in accordance with the present embodiment, the following effects can be obtained.

(1) When attaching the collet 16 to the shank 15 constituting the ultrasonic vibrating body, the collet 16 is firmly taken and attached into the taper hole 15A of the shank 15 by using the collet attaching device 21. On the other hand, when removing the collet 16 from the shank 15, the collet 16 can be taken out and removed from the taper of the shank 15 by using the collet removing device 22. Accordingly, it is possible to easily, rapidly and securely replace the cutting tool 1 inserted and attached to the collet 16.

(2) Since the collet attaching device 21 and the collet removing device 22 can be immediately separated from the shank 15 and the collet 16 after attaching and removing the collet 16, they do not generate a mass addition giving a bad influence to the vibration of the ultrasonic vibrating body. Accordingly, the collet attaching device 21 and the collet removing device 22 do not increase an oscillating energy of an ultrasonic vibration source and deteriorate an efficiency of vibration, so that it is possible to secure a stability of a machining performance of the ultrasonic vibration machining device 10.

(3) Since the collet 16 is provided with the screw portion 16D meshed with the collet removing device 22 and the collet removing device 22 can abut with the end surface of the shank 15, it is possible to remove the collet 16 from the shank 15 in accordance with a simple structure in which only the collet removing device 22 is used.

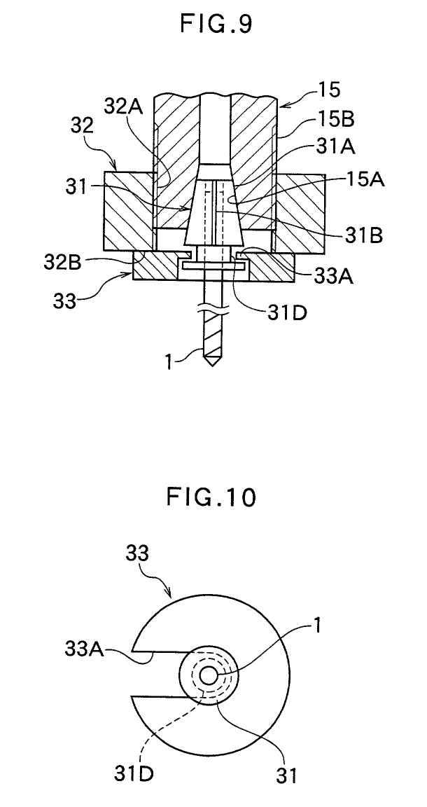

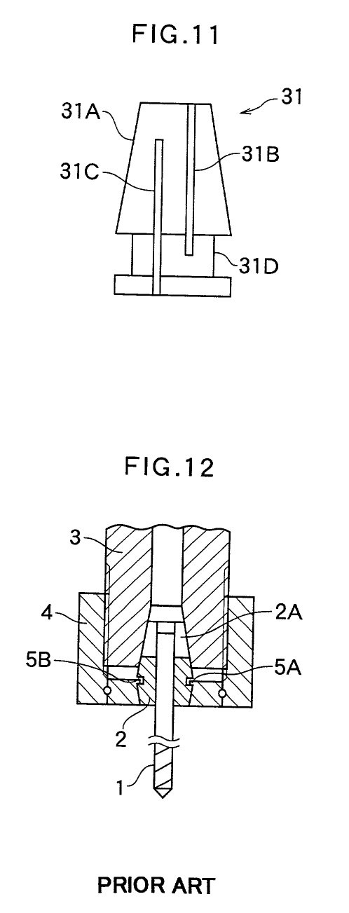

(Second Embodiment) (FIGS. 9 to 11)

A point at which the second embodiment differs from the first embodiment is that a collet 31 and a collet removing device 32 are respectively employed in place of the collet 16 and the collet removing device 22, and a collet removing piece 33 is additionally employed. In this case, the collet attaching device 21 mentioned above can be employed for attaching the collet 31.

The collet 31 is provided with a taper surface 31A and slits 31B and 31C in the same manner as that of the collet 16, as shown in FIG. 11, and is further provided with a ring groove 31D with which the collet removing piece 33 is engaged. At this time, the collet removing piece 33 is provided with a C-shaped engaging piece 33A which can be engaged with and removed from the ring groove 31D of the collet 31 from a lateral direction, as shown in FIGS. 9 and 10.

The collet removing device 32 has a screw portion 32A meshed with a screw portion 15B (also corresponding to the screw portion 15B for the collet attaching device 21) of the shank 15, and an abutting surface 32B which can abut with an end surface of the collet removing piece 33 engaged with and attached to the collet 31, as shown in FIGS. 9 and 10. Accordingly, the collet removing device 32 can remove the collet 31 from the taper hole 15A of the shank 15 via the collet removing piece 33 due to a screwing operation against the shank 15. Further, the collet removing piece 33 can be immediately separated from the collet 31 and the collet removing device 32 can be removed from the shank 15, after removing the collet 31 from the taper hole 15A of the shank 15.

In this case, a depressed recess by which an outer diameter of the end surface of the collet removing piece 33 can sit on the abutting surface 32B of the collet removing device 32 may be provided so as to prevent the collet removing piece 33 and the ring groove 31D of the collet 31 from being removed from each other at a time of removing the collet 31 by means of the collet removing device 32.

Therefore, in accordance with the present embodiment, the following effects can be obtained.

(1) At a time of attaching the collet 31 to the shank 15 constituting the ultrasonic vibrating body, the collet 31 is firmly taken and attached into the taper hole 15A of the shank 15 by using the collet attaching device 21. On the other hand, when the collet 31 from the shank 15, the collet 31 can be removed from the taper hole 15A of the shank 15 by using the collet removing device 32 and the collet removing piece 33. Accordingly, it is possible to easily, rapidly and securely replace the cutting tool 1 inserted and attached to the collet 31.

(2) Since the collet attaching device 21, the collet removing device 32 and the collet removing piece 33 can be immediately separated from the shank 15 and the collet 31 after attaching and removing the collet 31, they do not generate a mass addition giving a bad influence to the vibration of the ultrasonic vibrating body. Accordingly, the collet attaching device 21, the collet removing device 32 and the collet removing piece 33 do not increase an oscillating energy of an ultrasonic vibration source and deteriorate an efficiency of vibration, so that it is possible to secure a stable machine performance of the ultrasonic vibration machining device 10.

(3) Since the structure is made such that the collet 31 is provided with the ring groove 31D which can engage with and attach to the collet removing piece 33 and the collet removing device 32 can mesh with the shank 15 and always abut with the end surface of the collet removing piece 33, the collet removing device 32 can remove the collet 31 from the shank 15 without abutting with the end surface of the shank 15. When the machining space of the ultrasonic vibration machining device 10 is small, it is unavoidable to make the diameter of the end surface of the shank 15 small, however, in this case, there is no risk that the end surface does not plastically deform due to the abutment of the collet removing device 32, so that it is possible to improve a usability and a service life of the shank 15.

As heretofore explained, embodiments of the present invention have been described in detail with reference to the drawings. However, the specific configurations of the present invention are not limited to the embodiments but those having a modification of the design within the range of the present invention are also included in the present invention.

As mentioned above, in accordance with the present invention, in the ultrasonic vibration machining device, it is possible to easily, rapidly and securely replace the cutting tool without generating a mass addition to the shank constituting the ultrasonic vibrating body. Although the invention has been illustrated and described with respect to several exemplary embodiments thereof, it should be understood by those skilled in the art that the foregoing and various other changes, omissions and additions may be made to the present invention without departing from the spirit and scope thereof. Therefore, the present invention should not be understood as limited to the specific embodiment set out above, but should be understood to include all possible embodiments which can be embodied within a scope encompassed and equivalents thereof with respect to the features set out in the appended claims.

What is claimed is:

1. A cutting tool attaching and detaching apparatus of an ultrasonic vibration machining device in which a base end of a cutting tool is attached to a collet and a taper surface of said collet is connected to a taper hole provided in a shank of the ultrasonic vibration machining device in a taper manner, comprising:
a collet attaching device which is meshed with one of the shank and the collet, is engaged with another thereof in an axial direction, can take and attach the collet into the taper hole of the shank in accordance with a screwing operation for one of the shank and the collet, and can be separated from the shank and the collet; and
a collet removing device which is meshed with one of the shank and the collet, is engaged with another thereof in an axial direction, can take and remove the collet from the taper hole of the shank in accordance with a screwing operation for one of the shank and the collet, and can be separated from the shank and the collet.

2. A cutting tool attaching and detaching apparatus of an ultrasonic vibration machining device as claimed in claim 1, wherein said collet is provided with a screw portion meshed with the collet removing device, and said collet removing device can abut with an end surface of the shank.

3. A cutting tool attaching and detaching apparatus of an ultrasonic vibration machining device as claimed in claim 1, wherein said collet attaching device and said collet removing device are integrally formed so as to be used in a shape of a collet attaching and removing device.

4. A cutting tool attaching and detaching apparatus of an ultrasonic vibration machining device as claimed in claim 1, wherein said collet is provided with a ring groove which can engage and attach a collet removing piece, and the collet removing device can mesh with the shank and abut with an end surface of said collet removing piece.

5. A cutting tool attaching and detaching apparatus of an ultrasonic vibration machining device as claimed in claim 4, wherein a depressed recess is formed on the abutting surface of said collet removing device with the collet removing piece, so that the outer diameter of the end surface of the collet removing piece can sit on.
